(19) United States
(12) Patent Application Publication
(10) Pub. No.: US 2010/0031920 A1
(43) Pub. Date: Feb. 11, 2010

(54) Air Intake Device

(76) Inventor: Chang-Ho CHIEN, Shulin City (TW)

Correspondence Address: Troxell Law Office Pllc, Suite 1404, 5205 Leeburg Pike, Falls Church, VA, 22041, US

(21) Appl. No.: 12/187,496

(22) Filed: Aug. 7, 2008

(51) Int. Cl. F02B 31/04; F02M 35/10

(52) U.S. Cl. 123/306

(57) ABSTRACT

An air intake device, having application in engine air intake systems, and causes air to be rapidly and effectively guided into the engine fuel chambers, which primarily includes a plurality of swirl plates successively circumferentially formed on the inner walls of an air inlet end of an engine throttle body. When air is drawn into the air inlet end, then the swirl plates cause the air to form a vortex air current, which is used to increase the speed of mixing fuel with the air and improve the mixing rate, thereby enabling more complete fuel combustion in the engine fuel chambers.

### BACKGROUND OF THE INVENTION

(a) Field of the Invention

The present invention relates to an air intake device, which has application in engine air intake systems, and is used to guide air into the combustion chambers of an engine for mixing with fuel to enable combustion thereof. The present invention particularly provides an air intake device able to cause intaken air to form a vortex air current.

(b) Description of the Prior Art

Referring to FIG. 1, which shows a throttle body of an automobile engine of the prior art, wherein an air inlet 101 is formed at one end of a throttle body 10 of the drawing, and the air inlet 101 is used to guide the intake of air. The air inlet 101 is connected to an intake duct (not shown in the drawing); moreover, an air outlet 102 is formed at another end of the throttle body 10, and the air outlet 102 is connected to an intake manifold 1021, and the air outlet 102 is used to deliver the intaken air to the intake manifold 1021. A valve 103 is assembled interior of the throttle body 10, and pulling of the valve 103 using a throttle body cable or through an engine computer controlled electrically operated valve (not shown in the drawing) effects an opening or closing operation of the valve 103, thereby enabling an appropriate amount of the intaken air to be guided into the engine according to the action of the valve 103. Power of the engine comes from combustion of fuel, and combustion requires a substantial amount of air, hence, the engine not only needs to be able to appropriately supply fuel, but also needs to continuously draw air into the engine to enable combustion of the mixed fuel and air and produce the corresponding power therefrom. During an air inlet stroke, the engine pistons move downward and create a vacuum (that is, pressure diminishes) within the cylinders, thereby creating a pressure difference with the outside air causing the intake of air through an air intake duct, after which the air passes through the throttle body 10 into the engine combustion chambers, thereby enabling mixing of fuel and the air and accomplishing combustion within the engine combustion chambers. Hence, when air is drawn into the engine combustion chambers through the throttle body 10, because components, including an air filter, throttle body valve, and so on, within an air inlet cause obstruction to the intake of air, and temperature of the air taken into the cylinders is relatively high and density relatively low, that is, after intake, the air must flow for a period of time and pass obstructions before entering the interior of the engine cylinders and mixing with fuel to accomplish combustion, thus, such a configuration easily results in poor efficiency of air admission, causing a poor mixing rate of air and fuel, and thereby resulting in a situation which causes incomplete combustion, easily produces carbon deposition, and so on.

### SUMMARY OF THE INVENTION

In light of the shortcomings of the aforementioned prior art structure, the inventor of the present invention, having accumulated years of experience in related arts, has meticulously carried out extensive study and exploration to ultimately design a new air intake device.

A primary objective of the present invention is to provide an air intake device able to guide air admitted into an intake duct and form a vortex air current, thereby enabling a superior mixing rate of the air and fuel, and further enabling more complete combustion of the fuel.

In order to achieve the aforementioned objective, an air intake device of the present invention primarily comprises a plurality of swirl plates successively circumferentially formed on the inner walls of an air inlet of a throttle body. Accordingly, when the engine pistons move and form a vacuum state within the cylinders, then suction is created which causes an air intake valve to open and an exhaust valve to close to enable the intake of air, thereby causing external air to be drawn in through an intake duct, after which the air passes through the air inlet end of the engine throttle body, and then flows over the swirl plates of the air inlet end, whereupon the air is guided to form a vortex air current. The formed vortex air current thus rapidly enters the engine to improve the mixing rate of fuel and the air, thus achieving complete combustion effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an automobile engine throttle body of the prior art.

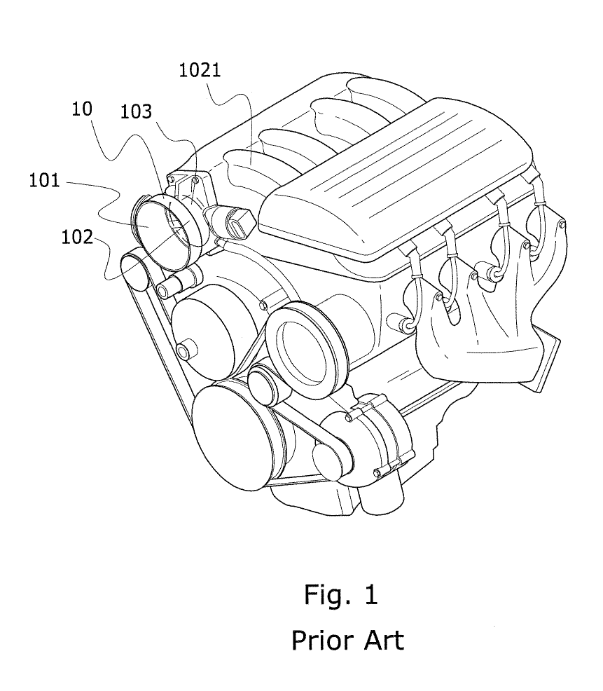

FIG. 2 is an external elevational view of the present invention.

FIG. 3 shows another embodiment (1) of the present invention.

FIG. 4 is a front view of the embodiment (1).

FIG. 5 shows another embodiment (2) of the present invention.

FIG. 6 shows another embodiment (3) of the present invention.

### DETAILED DESCRIPTION OF THE PREFERRED EMBODIMENTS

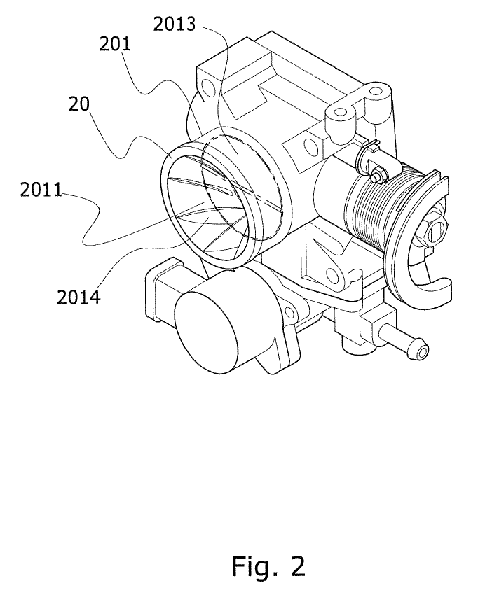

Referring to FIG. 2, which shows an external elevational view of the present invention, and an air intake device 20 depicted in the drawing is formed on an engine throttle body 201. An air inlet 2011 is formed at one end of the throttle body 201, and the air inlet 2011 is used to guide air taken in; moreover, the air inlet 2011 enables connection with an intake duct (not shown in the drawing). Another end of the throttle body 201 connects with an intake manifold (not shown in the drawing), and is used to guide the intaken air into the intake manifold. A valve 2013 is assembled interior of the throttle body 201, and pulling a throttle body cable or use of an engine computer controlled electrically operated valve (not shown in the drawing) enables an opening or closing operation of the valve 2013, thereby enabling an appropriate amount of air to be guided into the valve 2013 according to the action of the valve 2013. The inner walls of the air inlet 2011 of the air intake device 20 of the present invention are formed with a plurality of swirl plates 2014, and the plurality of swirl plates 2014 are separately successively circumferentially formed on the inner walls of the air inlet 2011. During an air inlet stroke, the engine pistons move downward and create suction within the cylinders, thereby creating a pressure difference with the outside air and causing the intake of air through the air intake duct, and after passing through the intake duct, the air flows into the air inlet 2011 of the engine throttle body 201, whereupon the plurality of swirl plates 2014 formed on the inner walls of the air inlet 2011 guide the air to form a vortex air current. Accordingly, such a vortex air current enables rapid intake of the air into the intake manifold, thereby reducing dissipation caused by obstruction during operation. Moreover, rapid intake of the vortex air current into the engine cylinders enables increasing the rate of mixing fuel and air, thereby causing more complete combustion of the fuel, as well as reducing carbon deposition, and so on.

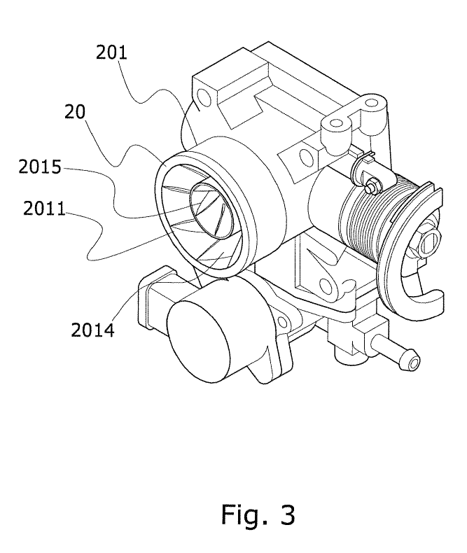

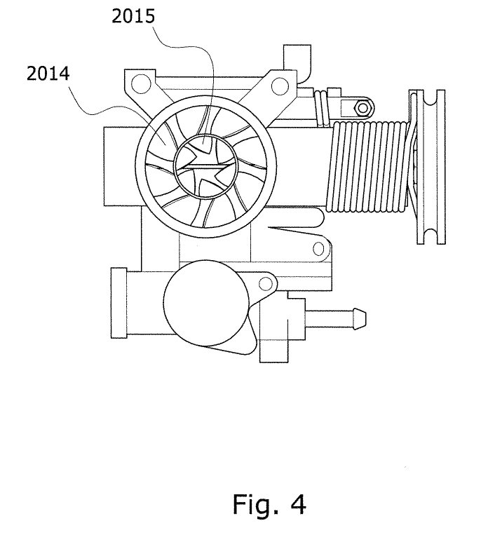

Referring to FIG. 3, which shows another embodiment (1) of the present invention, wherein, in order to increase the flow of air through the air inlet 2011 and realize better effectiveness in guiding the air to form a vortex air current thereafter, another set of swirl plates 2015 formed as an integral body (see FIG. 4, which shows a front view of the embodiment (1)) can be located at an appropriate position of the inner wall of the air inlet 2011 of the present invention. The swirl plates 2015 and the swirl plates 2014 assume a concentric cylindrical configuration, and vortex direction of the swirl plates 2015 can be identical to the vortex direction of the swirl plates 2014, or the vortex directions can be mutually opposite (the embodiment shown in the drawing depicts opposite directions). Accordingly, a better vortex air current is formed after air is taken in through the intake duct and flows past the swirl plates 2014 and the swirl plates 2015.

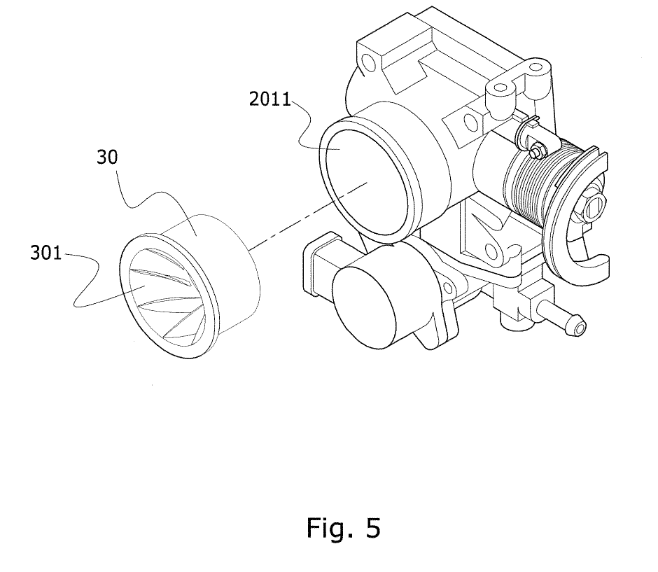

Referring to FIG. 5, which shows another embodiment (2) of the present invention, wherein the air intake device of the present invention can be further independently formed, which is after assembled to the air inlet 2011. As depicted in the drawing, a hollow cylindrical housing 30 is formed, and the inner walls of the hollow portion are separately successively circumferentially formed with a plurality of swirl plates 301. Aperture size of the housing 30 can be changed according to the aperture of the air inlet 2011, thereby enabling the housing 30 to be assembled to the air inlet 2011 with different apertures.

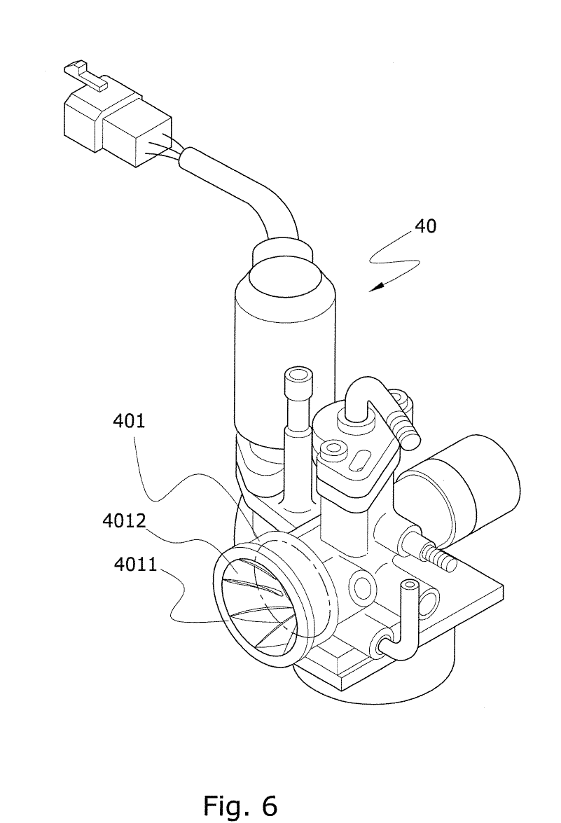

Referring to FIG. 6, which shows yet another embodiment (3) of the present invention, wherein the present invention also has application in motorcycle engines, as depicted in the drawing, which shows a throttle body 401 of a motorcycle engine 40, wherein an air inlet 4011 is formed at an end of the throttle body 401, and the inner walls of the air inlet 4011 of the embodiment are successively circumferentially formed with a plurality of swirl plates 4012. Accordingly, the plurality of swirl plates 4012 are used to cause the intaken air to form a vortex air current, thereby causing the air current to rapidly pass through the air inlet 4011 and enter the combustion chamber of the motorcycle engine 40, thus improving mixing rate of the air and fuel and causing more complete combustion of the fuel.

According to what has been described above, the present invention primarily uses a plurality of swirl plates successively circumferentially formed on the inner walls of an air inlet to cause the intake of air into an intake duct and enable a vortex air current to be produced after the air is guided to flow through an engine throttle body, thus causing the air to rapidly enter the cylinders of an engine and reducing dissipation of the air resulting from obstruction during the air intake process. Accordingly, the present invention assuredly achieves providing an air intake device able to increase mixing rate of fuel and air within engine cylinders, and thereby enable more complete combustion of the fuel and reduce carbon deposition.

To sum up, because the present invention is able to effect more complete fuel combustion, thus, the quantity of waste gases produced is reduced, including HC (hydrocarbon), CO (carbon monoxide), and so on, after fuel combustion, thereby better achieving environmental protection requirements.

In conclusion, effectiveness of the air intake device of the present invention is provided with new industrial applicability, originality and advancement, which comply with the essential elements as required for a new patent application, and in accordance with patent law, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An air intake device, having application in engine air intake systems, comprising:
a throttle body, the throttle body is assembled to an engine, and one end of the throttle body is formed with an air inlet; and
a plurality of swirl plates, the swirl plates are separately successively circumferentially formed on the inner walls of the air inlet.

2. The air intake device according to claim 1, wherein another set of swirl plates is formed at a central position of the plurality of swirl plates.

3. The air intake device according to claim 2, wherein vortex directions formed by the two sets of swirl plates are identical.

4. The air intake device according to claim 2, wherein vortex directions formed by the two sets of swirl plates are mutually opposite.

5. The air intake device according to claim 1, wherein the air intake device is used on a motorcycle engine.
